(19) United States
(12) Patent Application Publication
(10) Pub. No.: US 2006/0155596 A1
(43) Pub. Date: Jul. 13, 2006

(54) Revenue forecasting and sales force management using statistical analysis

(75) Inventor: Adam Thier, Burnsville, MN (US)

Correspondence Address: SHUMAKER & SIEFFERT, P. A., 8425 SEASONS PARKWAY, SUITE 105, ST. PAUL, MN, 55125, US

(73) Assignee: Cognos Incorporated, Ottawa, ON (CA)

(21) Appl. No.: 11/373,888

(22) Filed: Mar. 13, 2006

Related U.S. Application Data
(63) Continuation of application No. 09/575,599, filed on May 22, 2000.

(51) Int. Cl. G06F 17/30

(52) U.S. Cl. 705/10

(57) ABSTRACT

The invention is directed to statistically quantifying sales opportunities in order to forecast revenue and generate solution-oriented sales plans. The system includes a database of business opportunities and associated conditions. The database represents a mathematical model, such as a Bayesian model, where the conditions and business opportunities are represented as objects within the model. A statistical engine analyzes the database and generates a probability set indicating the probability of successfully achieving the business opportunities. A network interface allows a user, using a remote computer, telephone or personal digital assistant (PDA), to communicate with the system and input data, such as the status of the particular conditions. The statistical engine adaptively adjusts the model. A marketing engine generates a sale plan as a function of the probability set. The sales plan includes a list of activities necessary to achieve each business opportunities. A reporting engine generates a revenue report as a function of the probability set.

This application is a Continuation of Serial No. 09/575,599, filed May 22, 2000, the entire contents of which are incorporated herein by reference.

### TECHNICAL FIELD

The present invention relates to computer-implemented techniques for forecasting revenue and managing sales organizations.

### BACKGROUND

Businesses periodically perform detailed revenue forecasting in order to monitor revenue progress and to assist managers and executives in allocating resources to maximize revenue generation. Revenue forecasting, however, is a difficult and expensive task that often produces inaccurate results.

Conventionally, revenue forecasts have been built upon expressions of opinions from the sales organization as to the state of current business opportunities. For example, forms designed to elicit data for revenue forecasting often ask subjective questions such as “Are we winning?” The salesperson often provides his or her estimate as to the degree of “acceptance” of the product or service by the target customer. For example, the salesperson typically expresses a confidence level that the customer will ultimately purchase the product or service. These opinions are often influenced by many subjective factors such as the individual salesperson's perceptions and judgment regarding the opportunity. In addition, the salesperson often expresses biased optimism in order to secure more corporate resources for his or her business opportunities.

### SUMMARY

In general, the invention is directed to a system for statistically quantifying and mathematically modeling sales opportunities in order to forecast revenue and generate solution-oriented sales plans.

According to one aspect, the invention is directed to a system including a database of business opportunities and associated conditions. The conditions objectively represent activities performed by a sales organization and other facts that impact achieving the business opportunities. In this manner, the invention avoids the subjective input conventionally relied upon for revenue forecasting. For example, conditions may be defined to characterize the technology requirements of the target customer or the competition for a given business opportunity. A statistical engine executes within an operating environment of a computer to analyze the database and calculate a set of probabilities representing the probability of successfully achieving the business opportunities. In one configuration, the database stores a set of estimate probabilities received from a user representing preconceived probabilities for achieving the opportunities. The statistical engine applies Bayesian statistical techniques to calculate the probabilities of success as a function of the estimate probabilities and input data received from the sale organization. A network interface allows the sales organization to remotely update the status of the conditions using a communication device, such as a personal computer or personal digital assistant (PDA). A marketing engine generates a sales plan as a function of the first probability set. The sales plan includes a list of activities associated with achieving the business opportunities. A reporting engine generates a revenue report as a function of the first probability set.

According to another aspect, the invention is directed to a method in which a mathematical model is stored in a database, the model having a plurality of objects representing business opportunities and associated conditions. A first set of probabilities received from a user is also stored in the database. Input data is received from a sales organization, the input data indicating a status of a condition associated with one of the business opportunities. A second set of probabilities is calculated as a function of the input data and the first set of probabilities, the second set of probabilities indicating the probability of successfully achieving the business opportunities.

According to another aspect, the invention is directed to a computer-readable medium having data structures stored thereon. The data structures include a first data field to store a business opportunity. A first plurality of data fields store conditions, wherein a subset of the conditions represents activities performed by a sales organization. A second plurality of data fields store status of the conditions. A third plurality of data fields store a set of probabilities received from a user. A fourth plurality of data fields store a set of probabilities indicating the probability of successfully achieving each business opportunities. In one configuration, the fourth plurality of data fields are calculated as a function of the status fields and the third plurality of data fields.

Various embodiments of the invention are set forth in the accompanying drawings and the description below. Other features and advantages of the invention will become apparent from the description, the drawings, and the claims.

### BRIEF DESCRIPTION OF THE DRAWINGS

FIG. 1 is a block diagram illustrating a system for statistically quantifying sales opportunities in order to forecast revenue and generate solution-oriented sales plans.

FIG. 2 is a flow chart illustrating one implementation of a process to statistically quantify sales opportunities.

FIG. 3 illustrates an exemplary data entry form used by a sales organization to provide input data regarding business opportunities.

FIG. 4 graphically illustrates an exemplary model.

FIG. 5 illustrates an exemplary set of estimated probabilities provided by a user prior to receiving data from the sale organization.

FIG. 6 illustrates a sample sales plan.

FIG. 7 illustrates a sample revenue report.

FIG. 8 is a block diagram illustrating a computer suitable for implementing the various embodiments of the invention.

### DETAILED DESCRIPTION

In general, the invention is directed to systems and techniques for statistically quantifying sales opportunities in order to forecast revenue and generate solution-oriented sales plans. Unlike conventional systems, the revenue-forecasting system described herein statistically analyzes a set of conditions associated with each business opportunity.

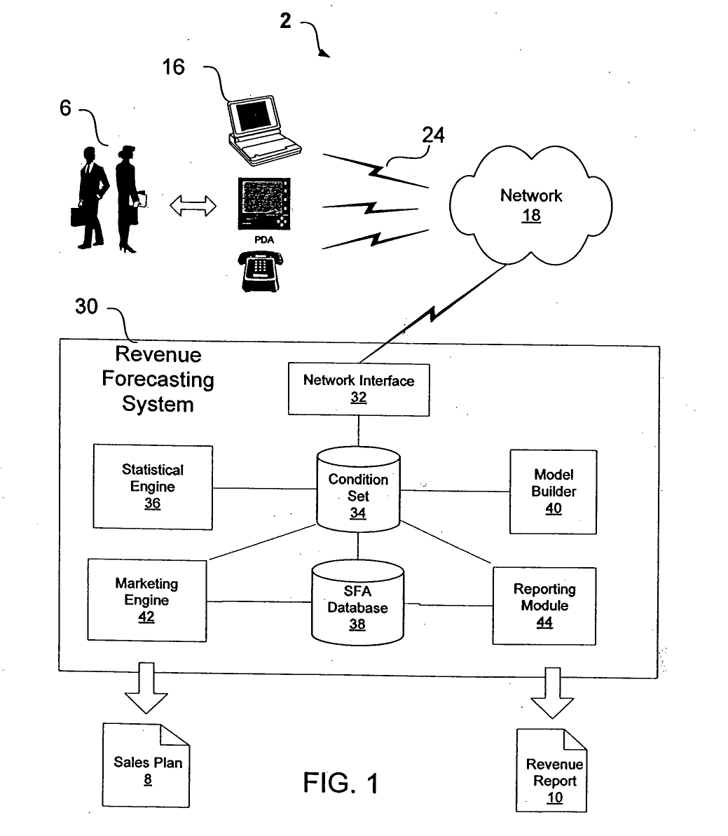

FIG. 1 is a block diagram illustrating a system 2 for statistically quantifying sales opportunities in order to forecast revenue and generate solution-oriented sales plans. Sales organization 6 interacts with potential customers and reports on their activities using communication devices 16. Communication devices 16 communicate input data received from sales organization 6 to revenue forecasting system 30 via network 18. In addition, sales organization 6 receives data from revenue forecasting system 30 via communication devices 16. For example, sales organization 6 can remotely retrieve and view sales plans 8 and revenue reports 10.

Communication devices 16 represent any communication device suitable for receiving input data from sales organization 6 and interfacing with network 18. One example of a suitable communication device 16 is a personal digital assistant (PDA) such as a Palm™ organizer from Palm Inc. of Santa Clara, Calif. Alternatively, communication device 16 can be a personal computer running a web browser such as Internet Explorer™ from Microsoft Corporation of Redmond, Wash. In addition, communication device 16 can be a conventional or cellular telephone. Communication devices 16 communicate with network 18 via communication signals 24. Network 18 represents any communication network, such as a packet-based digital network like the Internet.

Revenue forecasting system 30 includes network interface 32, condition set 34, statistical engine 36, sales force automation (SFA) database 38, model builder 40, marketing engine 42 and reporting engine 44. In one configuration, network interface 32 includes one or more web servers executing web server software, such as Internet Information Server from Microsoft Corporation, for communicating with communication devices 16. The web servers serve up web pages in response to access by communication devices 16. The web pages may include static media such as text and graphic imagery, as well as conventional input media such as text entry boxes, radio buttons, drop-down menus, and the like, for receipt of information from sales organization 6 associated with communication devices 16.

Condition set 34 defines a model that establishes relationships between business opportunities and “conditions” that are necessary to achieve the opportunity. In one configuration, condition set 34 is a database, such as a relational database managements system (RDBMS). Condition set 34 quantifies each business opportunity in terms of characteristics, activities and corresponding cost. Within condition set 34, each condition has a status. For example, the status may indicate whether a particular sales activity has occurred. Alternatively, the status may quantify the activity into one or more stages such as scheduled, in progress and, completed. Furthermore, the status may indicate whether the particular condition exists such as, for example, whether the target customer supports a particular database. A number of the conditions can be used to objectively characterize the target customer such as SIC code, revenue, profit, primary business sectors, technical infrastructures, decision makers, and current product or service to be displaced by the proposed sale. Other conditions objectively characterize the competition such as the major competitors competing for the business opportunity, their respective SIC codes, the products or services offered by the competitors and their respective market share. Other conditions objectively characterize the sales person such as success rate and average deal size. Still other conditions objectively characterize the sales activities that have occurred such as whether the salesperson has delivered marketing information to the target customer, whether the a technical overview of the product has been provided, whether a complete demonstration has been given and whether the customer is using an evaluation version.

Network interface 32 receives input data from communication device 6 via network 18 and updates the appropriate conditions within condition set 34. In one configuration, condition set 34 is implement using a database engine, such as SQL Server from Microsoft Corporation, executing on a database server. In this configuration, the database server may be coupled to network interface 32 via a packet-based local area network (LAN). In another configuration, network interface 32 is computer telephony equipment, such as a central PBX, that can receive input from conventional telephonic devices via conventional phone lines.

Statistical engine 36 uses logical operations to draw inferences from conditions set 10. Statistical engine 26 analyzes each opportunity within condition set 34 and the associated conditions and generates a probability of successfully achieving the business opportunity. In one configuration, statistical engine 36 is an expert system having an adaptive inference engine to adapt the inferences based on the input received from sales organization 6.

Sales force automation (SFA) database 14 is a relational database management system (RDBMS) for maintaining sales information such as contact information and company attributes including Standard Industry Code (SIC), size and products. SFA database 14 provides condition set 34 with a variety of information for each business opportunity including the volume of the potential products and services involved in the transaction and typical discount rates for the corresponding salesperson.

Model builder 32 allows a user, referred to as a model engineer, to graphically define a model for a given product or service. This typically involves researching historical sales data and identifying facts such as average sale size and sales per industry sector. The model engineer works with sales organization 6 and other executives to determine the business opportunities and conditions necessary to achieve the opportunities. As described in detail below, based on this input the model engineer interacts with model builder 32 to define a mathematical model. Model builder 32 generates condition set 34 in a relational database format.

In one configuration, statistical engine 36 applies Bayesian principles to forecast revenue. In this configuration, condition set 34 is organized as a Bayesian model having a plurality of objects interconnected by defined relationships. Each object in the model corresponds to one of the conditions within condition set 34. In one implementation, model builder 32 selects default attributes for the business opportunity based on the standard industry code (SIC code) of the target customer.

In one configuration, the Bayesian modeling approach applied by statistical engine 36 requires that the user provide estimates for a distribution over the unknown conditions of the model prior to receiving actual data from sales organization 6. Model builder 32 prompts the user for the estimated probabilities for each condition and any relevant weighted averages for the conditions. Model builder 32 stores the estimates, and their respective weightings, within condition set 34 as a first probability set.

After receiving data, statistical engine 36 applies Bayes' Rule to obtain a “posterior distribution” for the conditions based on both the estimated distribution provided by the model engineer and the actual data received from sales organization 6. From this posterior distribution, statistical engine 36 computes predictive distributions for future observations.

For example, given a set of data D received from sales organization 6 and a model M stored within condition set 34, the basic theorem of Bayes can be expressed as follows:

$$P ( M \text{\vert} D ) = P ( M ) [ \frac{P ( D \text{\vert} M )}{P ( D )} ]$$

P(M) represents the model itself as stored within condition set 34. P(D|M) is the likelihood of the data D in light of the model M and represents the prior estimates and weighted averages provided by the model engineer. The denominator P(D) is a normalization term such that the relative probabilities generated for different models on the same data can be calculated. The ability to explore different probability levels is highly advantageous for the revenue forecaster, permitting analysis of different “what if” scenarios. From these terms, statistical engine 36 calculates P(M|D), which represents the “posterior probability” of the model M in light of the data D, by evaluating the likelihood of the data D in light of model M, i.e., P(D|M).

The following equation illustrates how Bayes' rule can be used to calculate the posterior probability for model parameters, such as the mean, μ, and the variance, σ, as a function of the likelihood of the data D in terms of the parameters, a prior estimations for the parameters and a normalizing constant.

$$P ( μ , σ \text{\vert} D , M ) = [ \frac{P ( D \text{\vert} μ , σ , M ) P ( μ , σ \text{\vert} M )}{P ( D \text{\vert} M )} ]$$

The likelihood of the data D can be explicitly evaluated given values for μ, and σ. The prior estimation is a joint probability distribution over the parameters given the model assumptions entered by the model engineer and stored in condition set 34. The normalization term P(D|M) is the quantity of interest calculated by the first equation and can be extracted from the second equation by integrating the left hand side over all possible values of the model parameters.

Because integrating a distribution over all possible events gives unity, and because the denominator of the above equation is independent of μ and εr, the value of P(D|M) can be determined by the following equation:
P(D|M)=∫_{μσ}P(D|μ, σ, M)P(μ, σ|M)
Thus, statistical engine 36 applies the above equation to generate P(D|M), which it then uses to solve the first equation above and generate a posterior distribution P(M|D) for the conditions, i.e., probabilities with achieving the business opportunities. The integration can require considerable computing resources, depending on the form of the form of the prior estimation. Monte-Carlo numerical solutions can be used for some situation. In other situations, the integration can be approximated by summing probabilities of discrete models as described, for example, by D. MacKay in: Neural Computation, Vol. 4 (1992), No. 3, pp. 415-472, and no. 5, pp. 698-714, the entire content of which is incorporated by reference. In this manner statistical engine 36 calculates the posterior distribution P(M|D), which represents the probabilities of achieving the business opportunities based on the current state of the objective conditions and, therefore, can be used to objectively forecast revenue.

Condition set 34 stores P(D|M), which represents the based on the preconceived weighted averages provide by the model engineer, as a first probability set. As described above, statistical engine 36 analyzes the opportunities and conditions within condition set 34 to generate additional probability sets. For example, statistical engine 36 generates and stores the posterior distribution P(M|D) as a second probability set using statistical analysis techniques, such as the above-described Bayesian approach, to forecast revenue based on the model. Statistical engine 36 generates and maintains additional probability sets for “what-if” analysis. This allows a user, such as a sales manager, to change the conditions within condition set 34 and generate new probability sets. For example, the sales manager may wish to generate a new probability set that predicts revenue if a new competitor enters the market.

Based on the resultant sets of probabilities, marketing engine 130 generates sales plan 8 and corresponding marketing material. Sales plan 32 includes a prioritized list of business opportunities that should be pursued as well as a list of activities that must be performed to achieve each business opportunity. In addition, the cost for each activity is listed and a total cost for achieving each business opportunity is provided.

Reporting engine 44 generates a variety of revenue reports 10 providing a variety of information relating to revenue forecasting and sales generally. For example, reporting engine allows an executive to generate revenue reports 10 in a variety of formats such as: (1) opportunities by probability of achievement, (2) opportunities by resources requirements and (3) opportunities by potential return on investment (ROI).

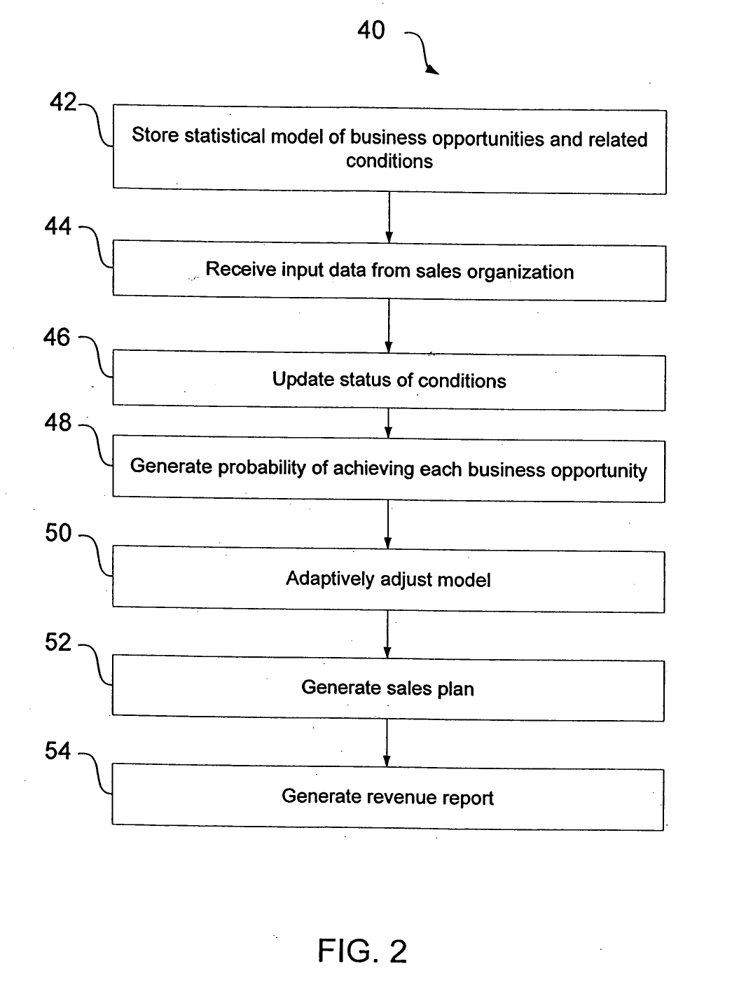

FIG. 2 is a flow chart illustrating one implementation of a process 40 to statistically quantify sales opportunities in order to forecast revenue and generate solution-oriented sales plans. Initially, the model engineer interacts with model builder 32 to develop and store condition set 34, which is a database of business opportunities and associated conditions that are organized and related to form a statistical model (42). Each condition within the model is associated with an object. A set of the objects represents conditions relating to sales activities for sales organization 6. Another set of the objects relate to characteristics of the business opportunity itself. Model builder 40 interacts with sales force automation database 38 to extract a list of customers and corresponding contacts such that condition set 34 can readily be developed and maintained. In one configuration, the mathematical model is a Bayesian model.

Next, revenue forecasting system 30 receives input data from sales organization 6 via network interface 32 (44). More specifically, sales organization 6 interacts with customers and provides input data indicating the status of one or more conditions for each business opportunity. Communication devices 6, such as a personal digital assistant, transmit the data over network 18, which may be a packet-based network is the Internet. For example, sales organization 6 may provide the data by accessing a web server within network interface 2 using a web browser executing on a communication device 6. Network interface 2 receives the data and updates the current status maintained within condition set 34 (46).

Statistical engine 36 analyzes condition set 34 and generates a probability set indicating the probability of successfully achieving each business opportunities (48). In one configuration, as described above, statistical engine 36 applies Bayesian techniques to generate the probabilities.

After analyzing the data received from sales organization 6, statistical engine 36 may perform trend analysis and adaptively adjust the model (50). For example, statistical engine 36 may recommend weightings for conditions within condition set 32 by comparing forecasted success probabilities with actual success rates. In addition, the model engineer may modify the estimated probabilities provided based on new input received from sales and marketing. The model engineer may also add or remove conditions from condition set 32.

Based on the generated probabilities for achieving the business opportunities, marketing engine 42 extracts information from SFA database and generates a sales plan as a function of the probability set (52). Reporting engine 44 extracts information from condition set 34 and generates revenue reports 10 (54).

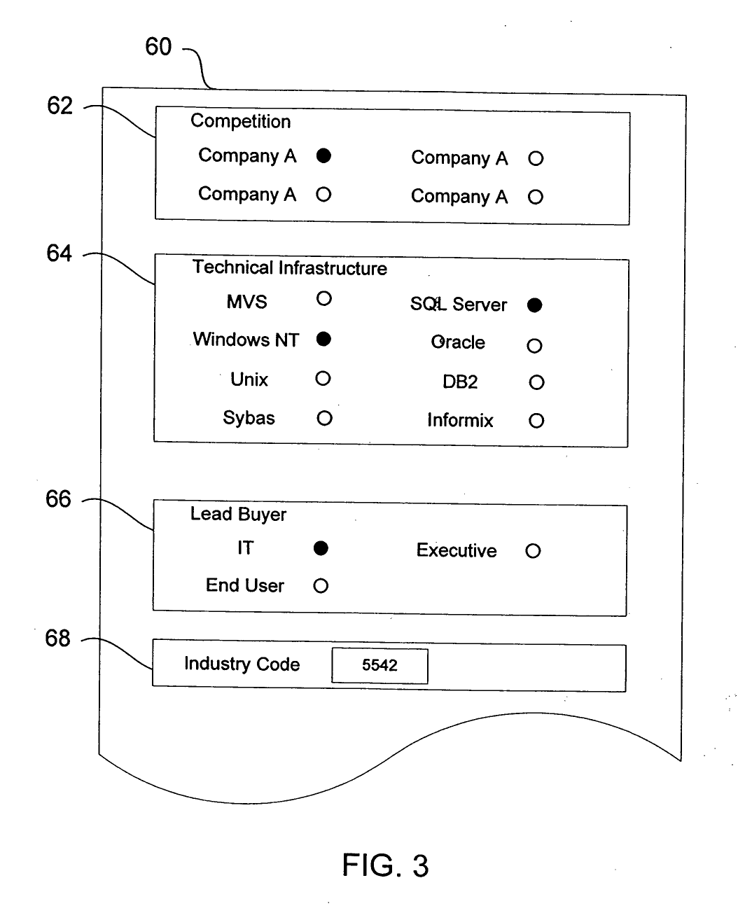

FIG. 3 illustrates an exemplary data entry form 60 used by sales organization 6 to provide input data regarding individual business opportunities. Network interface 32 communicates data entry form 60 to communication devices 16 for data input. For example, data entry form 60 can be defined in hypertext markup language (HTML) for capturing data via a web browser.

Data entry form 60 includes a number of input areas for objectively capturing status information from sales organization 6. For example, in input area 62, the salesperson indicates the primary competitors with which the salesperson is competing on a particular business opportunity. In input area 64, the salesperson reports on the technical infrastructure of the target customer by selecting one or more platforms required by the customer. For example, the salesperson indicates what type of operating systems and database engines the target customer requires. In input area 66, the salesperson indicates the individuals that influence and would ultimately approve the purchase of the deliverable at the target customer such as an executive, an end user or an information technology (IT) member. In input area 68, the salesperson indicates the SIC code for the target customer. Data entry form 60 can readily be extended to capture other data such as the status with sales activities.

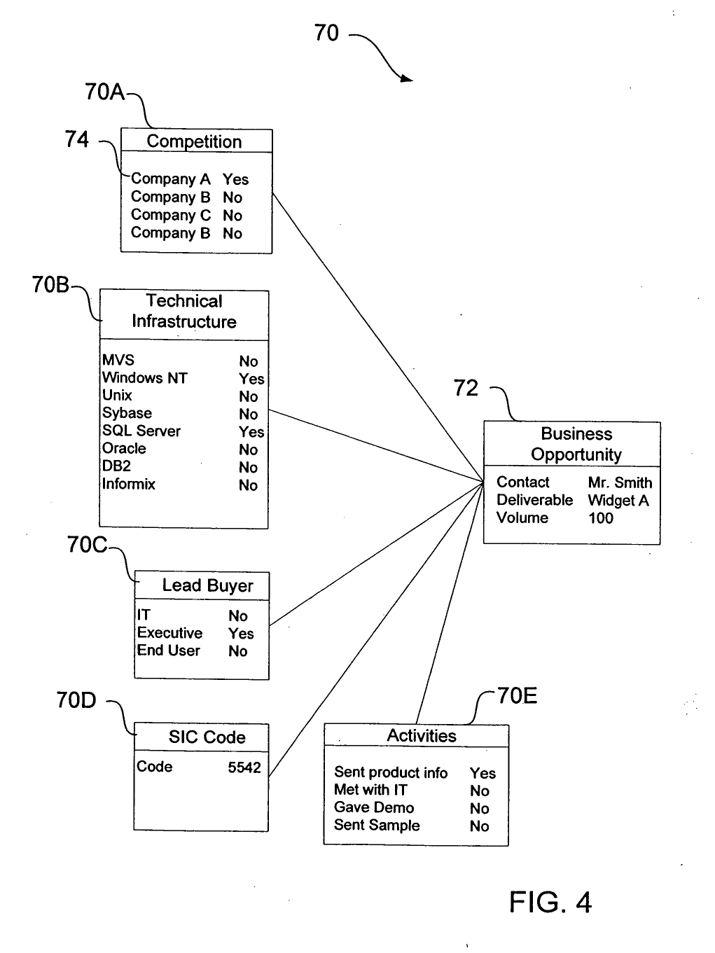

FIG. 4 graphically illustrates an exemplary model 70 stored within condition set 34. Model 70 has a business opportunity object 72 for storing information relating to individual business opportunities. Each business opportunity object 72 is associated with a plurality of condition objects 72A through 72E. Each condition object 72 corresponds to a condition and stores information that characterizes the related opportunity or activities necessary for achieving its success. As such, each condition object has one or more information fields and a corresponding status. For example, the competition condition 70A has four information fields 74 indicating the primary competitors for the opportunity.

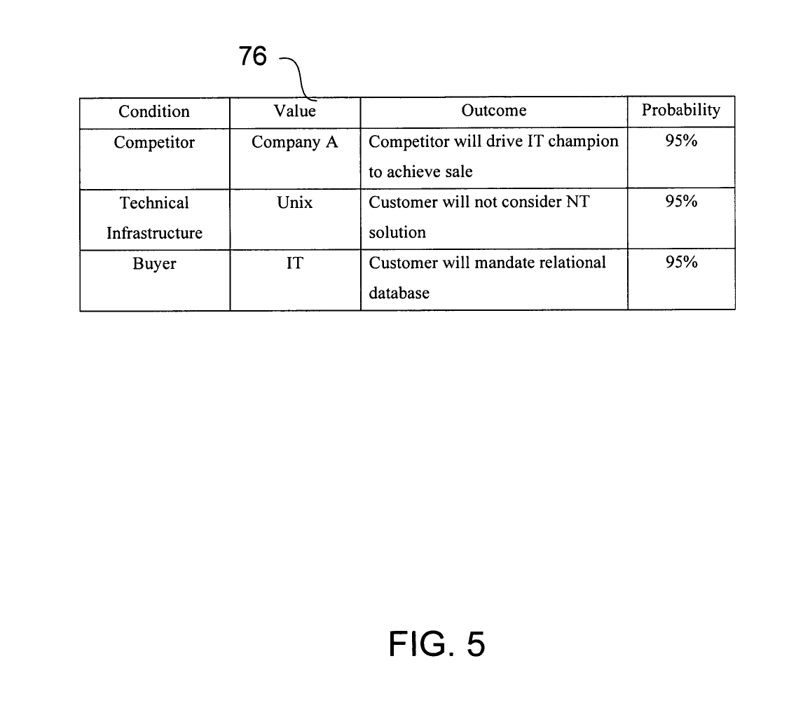

FIG. 5 illustrates an exemplary set 76 of initial probabilities based on preconceived estimates prior to receiving data from sale organization 6. As such, these probabilities correspond with P(D|M) used in the Bayesian analysis described above. Each probability relates to one of the conditions defined in the model and described a predicted outcome with a relative probability. For example, the first probability indicates that Company A is a competitor, and that there is a 95% probability that Company A will attempt to drive the sale through an IT champion at the target customer.

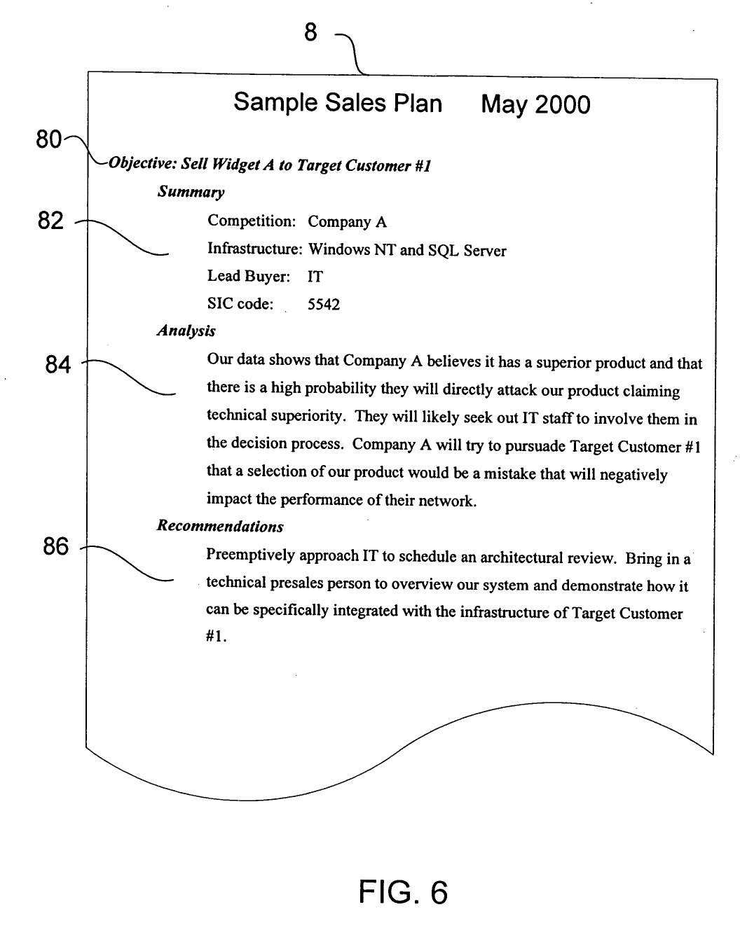

FIG. 6 illustrates a sample sales plan 8 generated by marketing engine 42. For each business opportunity 80, sales plan 8 provides a summary 82 of the data entered by sales organization 6. Next, sales plan 8 provides an analysis section that provides the output of statistical engine 36 after analyzing condition set 34 as described above. Finally, for each business opportunity 80, sales plan 8 provides a recommendation section 86 that provides concise actions that should directly increase the probability of achieving the business objective 80.

For example, summary 82 indicates that the salesperson entered Company A as a primary competitor for business opportunity 80. As such, statistical engine 36 determines that there is a high probability that Company A will promote the technical strengths of its product and attack the technical strength of any competition, as reported by analysis section 84. Accordingly, statistical engine 36 provides recommendation section 86 that includes a number of actions to increase the probability of achieving the business opportunity.

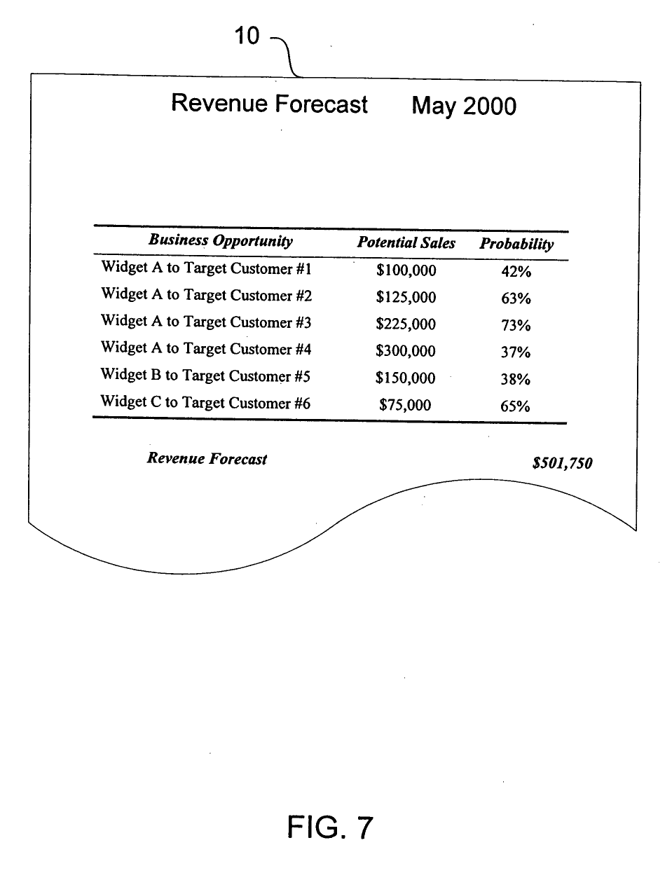

FIG. 7 illustrates on example of a revenue report 10 generated by reporting engine 44. Revenue report 10 lists a number of business opportunities as well as potential revenue from each opportunity and the calculate probability of achieving each opportunity as determined by statistical engine 36. Based on these probabilities, revenue report 10 provides a total revenue forecast. The inventive revenue forecasting techniques described herein can be implemented in digital electronic circuitry, or in computer hardware, firmware, software, or in combinations of them. Furthermore, the invention can be implemented in a computer program tangibly embodied in a machine-readable storage device for execution by a programmable processor within an operating environment of a programmable system.

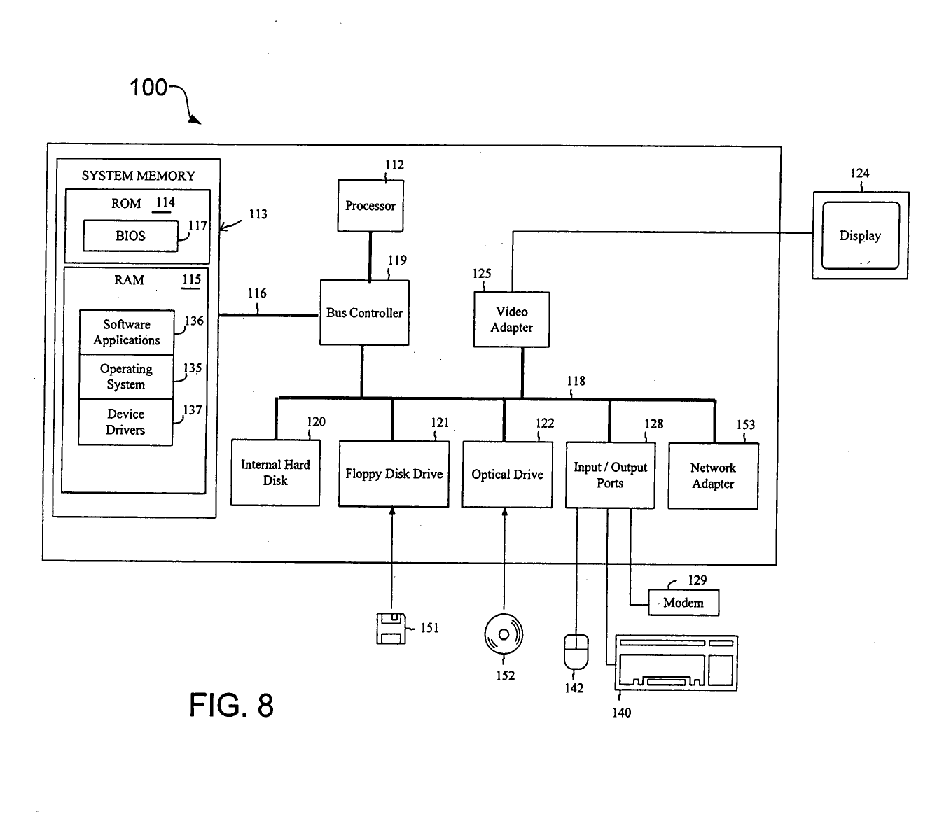

FIG. 8 illustrates a programmable computing system (system) 100 that provides an operating environment suitable for implementing the techniques described above. The system 100 includes a processor 112 that in one embodiment belongs to the PENTIUM® family of microprocessors manufactured by the Intel Corporation of Santa Clara, Calif. However, the invention can be implemented on computers based upon other microprocessors, such as the MIPS® family of microprocessors from the Silicon Graphics Corporation, the POWERPC® family of microprocessors from both the Motorola Corporation and the IBM Corporation, the PRECISION ARCHITECTURE® family of microprocessors from the Hewlett-Packard Company, the SPARC® family of microprocessors from the Sun Microsystems Corporation, or the ALPHA® family of microprocessors from the Compaq Computer Corporation. In various configurations, system 100 represents any server, personal computer, laptop or even a battery-powered, pocket-sized, mobile computer known as a hand-held PC or personal digital assistant (PDA).

System 100 includes system memory 113, including read only memory (ROM) 114 and random access memory (RAM) 115, which is connected to the processor 112 by a system data/address bus 116. ROM 114 represents any device that is primarily read-only including electrically erasable programmable read-only memory (EEPROM), flash memory, etc. RAM 115 represents any random access memory such as Synchronous Dynamic Random Access Memory.

Within the system 100, input/output bus 118 is connected to the data/address bus 116 via bus controller 119. In one embodiment, input/output bus 118 is implemented as a standard Peripheral Component Interconnect (PCI) bus. The bus controller 119 examines all signals from the processor 112 to route the signals to the appropriate bus. Signals between the processor 112 and the system memory 113 are merely passed through the bus controller 119. However, signals from the processor 112 intended for devices other than system memory 113 are routed onto the input/output bus 118.

Various devices are connected to the input/output bus 118 including hard disk drive 120, floppy drive 121 that is used to read floppy disk 151, and optical drive 122, such as a CD-ROM drive that is used to read an optical disk 152. The video display 124 or other kind of display device is connected to the input/output bus 118 via a video adapter 125.

Users enter commands and information into the system 100 by using a keyboard 140 and/or pointing device, such as a mouse 142, which are connected to bus 118 via input/output ports 128. Other types of pointing devices (not shown) include track pads, track balls, joysticks, data gloves, head trackers, and other devices suitable for positioning a cursor on the video display 124.

System 100 also includes a modem 129. Although illustrated as external to the system 100, those of ordinary skill in the art will quickly recognize that the modem 129 may also be internal to the system 100. The modem 129 is typically used to communicate over wide area networks (not shown), such as the global Internet. Modem 129 may be connected to a network using either a wired or wireless connection.

Software applications 136 and data are typically stored via one of the memory storage devices, which may include the hard disk 120, floppy disk 151, CD-ROM 152 and are copied to RAM 115 for execution. In one embodiment, however, software applications 136 are stored in ROM 114 and are copied to RAM 115 for execution or are executed directly from ROM 114.

In general, the operating system 135 executes software applications 136 and carries out instructions issued by the user. For example, when the user wants to load a software application 136, the operating system 135 interprets the instruction and causes the processor 112 to load software application 136 into RAM 115 from either the hard disk 120 or the optical disk 152. Once one of the software applications 136 is loaded into the RAM 115, it can be used by the processor 112. In case of large software applications 136, processor 112 loads various portions of program modules into RAM 115 as needed.

The Basic Input/Output System (BIOS) 117 for the system 100 is a set of basic executable routines that have conventionally helped to transfer information between the computing resources within the system 100. Operating system 135 or other software applications 136 use these low-level service routines. In one embodiment system 100 includes a registry (not shown) that is a system database that holds configuration information for system 100. For example, the Windows® operating system by Microsoft Corporation of Redmond, Wash., maintains the registry in two hidden files, called USER.DAT and SYSTEM.DAT, located on a permanent storage device such as an internal disk.

The invention has been described in terms of particular embodiments. Other embodiments are within the scope of the following claims. For example, the steps of the invention can be performed in a different order and still achieve desirable results. This application is intended to cover any adaptation or variation of the present invention. It is intended that this invention be limited only by the claims and equivalents thereof.

What is claimed is:

1. A method comprising:
storing a mathematical model in a database, wherein the model includes a plurality of objects representing business opportunities and associated conditions for achieving the business opportunities;
storing a first set of probabilities received from a user representing estimated probabilities for achieving the opportunities;
receiving input data from a sales organization indicating a status of at least one condition associated with one of the business opportunities; and
calculating a second set of probabilities as a function of the input data, the mathematical model, and the first set of probabilities, wherein the second set of probabilities indicates the probability of successfully achieving the business opportunities.
